(19) United States
(12) Patent Application Publication
(10) Pub. No.: US 2002/0122713 A1
(43) Pub. Date: Sep. 5, 2002

(54) Distributive livestock feeding apparatus

(76) Inventor: Martin M. Muller, Birmingham, AL (US)

Correspondence Address: Robert J. Veal, BURR & FORMAN LLP, Post Office Box 830719, Birmimgham, AL, 35283-0719, US

(21) Appl. No.: 09/797,896

(22) Filed: Mar. 1, 2001

(51) Int. Cl. B60P 3/00; B60P 1/00

(52) U.S. Cl. 414/528; 414/502

(57) ABSTRACT

A distributive livestock feeding apparatus for dispensing discrete portions of baled livestock feed, such as hay, for consumption by livestock.

### FIELD OF THE INVENTION

The present invention relates to a livestock feeding apparatus. In particular, the present invention relates to a livestock feeding apparatus that distributes discrete portions of baled feeds, such as hay, for consumption by livestock.

### BACKGROUND OF THE INVENTION

Traditionally, livestock producers have used baled hay and similar feed products to sustain their herds when available pastures, for various reasons, will not support grazing thereon by the herd. While baled feeds provide producers the means for efficiently storing large quantities of livestock feed, the bales present distribution problems for the producer.

The baled feeds need to be broken down and dispensed in discrete portions to permit each member of the herd ample food and space to eat. Ideally, the baled feeds should be dispensed such that a uniform distribution of the feeds to the herd is achieved. Manual means may be appropriate when only a few animals require feeding. However, with even a modest herd, manual means quickly become cost prohibitive.

Several prior art devices have been employed to solve this problem. In large part, these devices employ some form of reciprocating means controlling either the opening and closing of the outlets of a hopper, or the controlling the delivery of discrete portions of feed to the apparatus outlet. These devices can be complex and subject the reciprocating parts to mechanical failure and excessive maintenance. What is needed is a simpler device to accomplish distribution of discrete portions of baled feed.

### SUMMARY OF THE INVENTION

It is the object of the present invention to provide a simple, cost-effective means for transporting baled feeds and distributing discrete portions thereof to livestock. It is a further object of the present invention to take advantage of the flaking properties of baled feeds and thereby eliminate the need for reciprocating parts to control the delivery of discrete portions of feed. It is a further object of the present invention to provide a system that may be expanded to accommodate various herd sizes.

The apparatus contemplated by the present invention comprises a mobile vehicle frame for supporting and moving the apparatus and baled feed. A plurality of support shelves is attached to the vehicle frame extending lengthwise along the longitudinal length of the mobile frame. Bales of feed are loaded end to end on the support shelves.

The discrete portions of baled feed are dispensed as the vehicle moves across a field containing the livestock. The feed bales are urged rearwardly on the support shelves by conveyor means such as a bale spike extending from an endless drive chain, the endless drive chain being operatively driven by a power takeoff (PTO) shaft from a tractor pulling the frame or from drive means embodied on the apparatus.

As the bales of feed are urged rearwardly, portions of the formed bales will extend beyond the aft end of the support shelves. The extending portions will eventually reach a point where they will flake away from the remainder of the formed bales and be deposited on the ground.

Dispersion of the deposited feed portions is achieved by regulating the speed of the conveyor relative the speed of the vehicle frame across the field.

### BRIEF DESCRIPTION OF THE DRAWINGS

Apparatus embodying features of my invention are depicted in the accompanying drawings, which form a portion of this disclosure wherein:

FIG. 1 is a side view of the baled feed dispensing apparatus of the present invention;

FIG. 2 is a plan view of the baled feed dispensing apparatus of the present invention; and

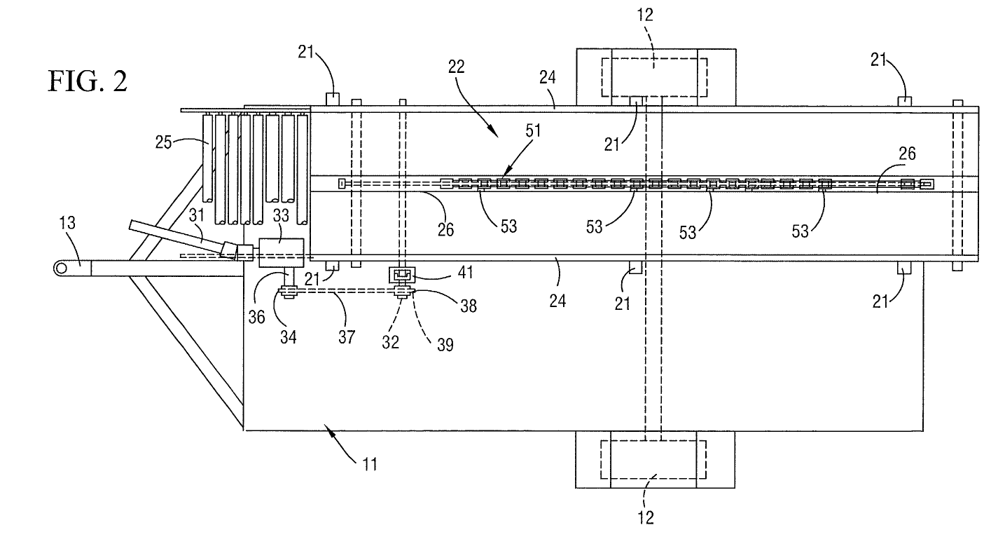

FIG. 3 is rear view of the baled feed dispensing apparatus of the present invention.

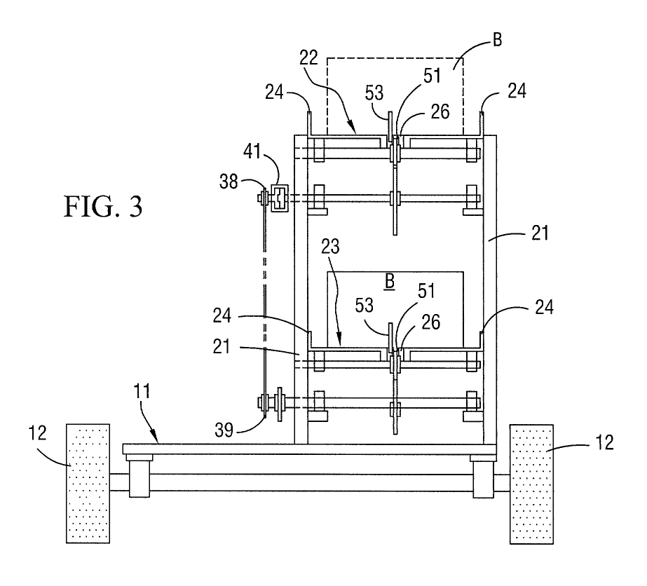

FIG. 4 is a rear view of an alternative embodiment of the baled feed dispensing apparatus of the present invention.

FIG. 5 is a rear view of a third embodiment of the baled feed dispensing apparatus of the present invention.

### DESCRIPTION OF THE PREFERRED EMBODIMENT

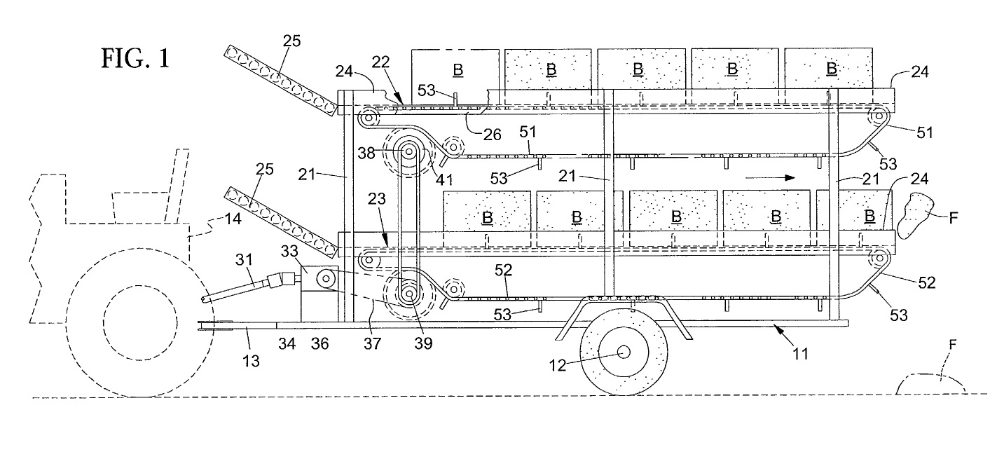

Referring to the drawings for a clearer understanding of the invention, it may be seen in FIG. 1 that the apparatus of the specific embodiment described herein includes a trailer frame 11 mounted on a wheeled axle 12. A tongue 13 extends from the forward end of trailer frame 11; tongue 13 is adapted to be received by a tow point on a standard farm tractor 14 or similar vehicle. Alternatively, the apparatus claimed may be mounted on a self-propelled vehicle and achieve the same results.

A plurality of support members 21 attached to frame 11 provides attachment and support means for bale support shelves 22 and 23. Bale support shelves 22 & 23 receive a plurality of formed rectangular feed bales B end to end thereon. Loading of feed bales B may be assisted by including a bale shelf-loading track 25 attached to forward ends of bale support shelves 22 and 23. If feed bales B are bound by wire or twine, the wire or twine should be severed before commencing dispensing operations, preferably after completing transporting operations covering significant distances. Bale support shelves 22 and 23 have bale guides 24 extend parallel to the longitudinal edges of support shelves 22 and 23. Bale guides 24 have a sufficient vertical height to retain feed bales B in longitudinal alignment with support shelves 22 and 23, retain feed bales B during transport and dispensing operations and guide bales B along support shelves 22 and 23 during dispensing operations. Bale support shelves 22 and 23 have a slot 26 extending through their longitudinal centerlines for receiving bale conveyor means.

In the preferred embodiment, a rotary power takeoff shaft (PTO) 31 extends from the rear of tractor 14 to provide conveyor drive means. Alternatively, conveyor drive means may be provided by a PTO shaft on a self-propelled vehicle or by a power plant or motor added to the apparatus. PTO 31 is operatively connected to endless chain conveyors 51 and 52 through a conveyor drive shaft 32 and a gearbox 33, which is attached to the forward end of trailer frame 11. Gearbox 33 has drive sprocket 34 attached to its output shaft 36. Drive sprocket 36 engags a drive chain 37 which is selectively engageable, by means of an electric clutch 41, with an upper driven sprocket 38 to drive endless chain conveyor 51 or lower driven sprocket 39 to drive endless chain conveyor 52.

Bale spikes 53 extending outwardly from endless chain conveyors 51 and 52 provide conveyor means. Endless chain conveyors 51 and 52 are positioned within slot 26 of support shelves 22 and 23 such that bale spikes 53 have sufficient extension for penetrating engagement of bales B, permitting bale spikes 53 to urge bales B rearward on pre-selected support shelf 22 or 23.

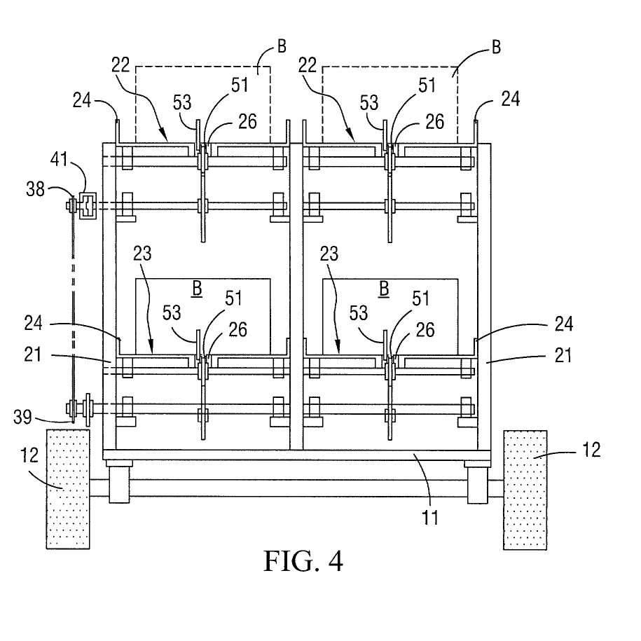

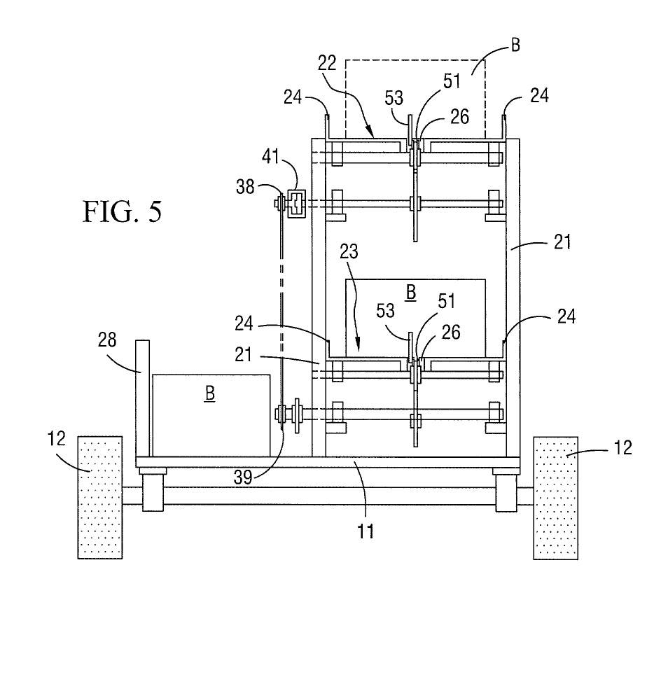

For substantially larger herds of livestock, multiple bale support shelves 22 & 23 may be added to the apparatus, as shown in FIG. 4, thereby increasing the capacity of the apparatus. Subsequent shelves may be selectively engagegable with drive means for either parallel or serial distribution of baled feeds to the herd. Alternatively, where only small increases in capacity are required, bale support shelves 22 & 23 may be offset to a side of the apparatus, as shown in FIG. 5, thereby providing storage shelf 27 for simply stacking additional bales of feed on the bed of the mobile vehicle frame. A guardrail 28 is attached to trailer frame 11 to retain bales B on the apparatus. The stored bales are manually transferred to support shelves 22 & 23 after distribution of the bales carried thereon.

To prepare for feed bale distribution, the operator severs any wires or twine binding bales B together. Horses appear to discriminate between the dispensed feed and twine while feeding, however, for other livestock, it may be desirable to retrieve the twine or wire before commencing feed dispensing operations to prevent such livestock from being injured by consumption of the twine. The operator selects a feed bale support shelf 22 or 23 from which to dispense feed bales B. The tractor 14 pulls the feed apparatus across a field or pasture. When the operator is in position to dispense feed, the operator engages PTO shaft 31, which drives conveyor 51 or 52. Bale spikes 53 urge feed bales B rearwardly along selected support shelf 22 or 23. Referring to FIG. 1, as the feed bales B are urged rearwardly, portions of the feed bales B will extend beyond the aft end of the selected support shelf 22 or 23. The extending portions will eventually reach a point where they will flake away from the remainder of the formed bales by gravity, or bouncing of the trailer 11 over surface irregularities in the field, and be deposited on the ground.

The dispersion of deposited bale flakes F on the ground is controlled by transmission means comprising, selecting PTO shaft 31 speed, selecting gearbox 33, drive sprocket 34 and driven sprocket 38 and 39 ratios, and controlling the rate at which the apparatus is towed across the field or pasture.

It is to be understood that the form of the invention shown is a preferred embodiment thereof and that various changes and modifications may be made therein without departing from the spirit of the invention or scope as defined in the following claims.

I claim:

1. An apparatus for distributing rectangular baled livestock feeds, such as hay, comprising:
a. a mobile vehicle frame;
b. a plurality of longitudinally extending substantially horizontal bale support shelves comprising an aft end extending beyond said vehicle frame;
c. conveyor drive means; and
d. conveyor means operatively connected to said conveyor drive means, said conveyor means urging said baled feed rearwardly along said bale support shelves and said baled feed distributed from said support shelf aft end.

2. The apparatus of claim 1, wherein said support shelves further comprise a bale shelf loading track, said loading track operatively connected to forward ends of said bale support shelves.

3. The apparatus of claim 1, wherein said bale support shelves comprise a plurality of bale guides extending substantially parallel longitudinal edges of said support shelves, said bale guides extending a predetermined height above said support shelf edges, such that said bale guides retain said bales in alignment relative said support shelves longitudinal length, said bale guides attached to said support shelves by a plurality of support members.

4. The apparatus of claim 1, wherein said conveyor means comprising an endless drive chain loop, a plurality of drive chain support sprockets, said sprockets supporting said a drive chain loop substantially parallel said bale support shelves longitudinal length, and a plurality of bale spikes interspersed along said drive chain loop, said bale spikes outwardly extending from said drive chain, said drive chain positioned and said bale spikes having sufficient length to engage said baled feed, said drive chain and drive spikes urging said baled feed rearwardly along said bale support shelves.

5. The apparatus of claim 1, wherein said conveyor drive means comprise a rotating power takeoff (PTO) shaft, said shaft operatively connected via transmission means to rotate a drive sprocket operatively engaging said endless drive chain loop.

6. The apparatus of claim 5, wherein said transmission means comprise a predetermined gear reduction corresponding to the desired distribution rate of said baled livestock feed.

7. The apparatus of claim 6, wherein said transmission means further comprise a clutch mechanism for selectively engaging said conveyor means corresponding with a desired bale support shelf for distributing the baled livestock feed thereon.

8. The apparatus of claim 1 further comprising a storage shelf adjacent said support shelves comprising a flat horizontal surface extending parallel said support shelves and attached to said mobile vehicle frame, said storage shelf having a predetermined width at least equal to the width of said feed bale.

9. The apparatus of claim 8 further comprising a guardrail attached along a longitudinal length of said vehicle frame adjacent said storage shelf.
